(19) United States
(12) Patent Application Publication
(10) Pub. No.: US 2013/0087276 A1
(43) Pub. Date: Apr. 11, 2013

(54) MEDIUM SUPPORT MEMBER

(71) Applicant: OCE-TECHNOLOGIES B.V., Venlo (NL)

(72) Inventor: Cameron MATTHEWS, Chilliwack (CA)

(73) Assignee: OCE-TECHNOLOGIES B.V., Venlo (NL)

(21) Appl. No.: 13/690,157

(22) Filed: Nov. 30, 2012

Related U.S. Application Data
(63) Continuation of application No. PCT/EP2011/059112, filed on Jun. 1, 2011.
(60) Provisional application No. 61/354,462, filed on Jun. 14, 2010.

(30) Foreign Application Priority Data
Jun. 14, 2010 (EP) 10165794.8

(51) Int. Cl. B25B 11/00

(52) U.S. Cl. CPC B25B 11/005
USPC 156/272.4; 269/21

(57) ABSTRACT

A medium support member includes a table having a top surface; an overlay placed on the top surface of the table, the overlay having a top surface and a bottom surface and a plurality of through-holes; a spacer array provided between the top surface of the table and the bottom surface of the overlay to define a gap between the table and the overlay, and at least one vacuum passage communicating with said gap for creating an underpressure in the gap, wherein at least portions of the overlay and corresponding portions of the table are held together by magnetic attraction.

### BACKGROUND OF THE INVENTION

1. Field of the Invention

The invention relates to a medium support member, especially for print media, and a method of forming a medium support member.

2. Description of the Background Art

In the field of printing, it is known to use medium support members for holding and flattening of print media during a print process in which the print media are scanned with a printhead. It is known to use a suction box as medium support member. Such a suction box usually has a perforated top surface, and the inner volume of the suction box is maintained at an underpressure by means of a vacuum pump.

It is a disadvantage of this kind of medium supports that the suction box must have a very complex structure in order to be able to evenly distribute the underpressure from the suction device over the surface of the print medium.

As the distance between the printhead and the print medium must be very well defined and preferably constant over the whole print area, the support surface should be very perfectly flat.

US 2008/0055382 A1 discloses a medium support member comprising:

a table having a top surface;

an overlay placed on the top surface of the table, the overlay having a top surface and a bottom surface and a plurality of through-holes;

a spacer array provided between the top surface of the table and the bottom surface of the overlay to define a gap between the table and the overlay, and

at least one vacuum passage communicating with said gap for creating an underpressure in the gap.

The spacers of the spacer array are formed by punching the overlay, which may be formed by a sheet metal, so that depressions or recesses are formed in the top surface of the overlay and projections corresponding to these recesses are formed in the bottom surface of the overlay. The spacers define a gap with a well-defined width between the overlay and the top surface of the table. Further, since the spacers are arranged in the form of separate islands, the hollow space surrounding the spacers forms a distribution manifold for evenly distributing the suction pressure over the through-holes in the overlay.

When a sheet of a print medium is placed on the top surface of the overlay, the underpressure results in a force that will firmly draw the sheet against the overlay. Since the size of the print media may sometimes be smaller than the area of the medium support member, there may be a case where not all of the through-holes in the overlay are covered by the print medium sheet, but through-holes in a marginal area of the overlay are left open. In these areas, the overlay is held on the surface of the table only by gravity, assisted by a certain flow resistance which the through-holes will provide for the air that is being drawn in. The overlay, which may be relatively thin and flexible, should be safely prevented from forming warps which, in view of the very small distance between the printhead and the surface of the print medium, might lead to collisions between the printhead and upwardly bulged surface areas of the print medium or the support surface.

Medium support members according to the preambles of claim 1 are disclosed in JP 2008 238674 A and US 2008/174652 A1.

### SUMMARY OF THE INVENTION

It is an object of the invention to provide a medium support member wherein the overlay is reliably secured on the top surface of the table.

In the medium support member according to the invention, magnetic strips are secured to the overlay, and the the table is made of a magnetically attractable material, and in that the spacer array comprises spacers that are formed by the magnetic strips.

Thus, the overlay will safely be attracted towards the surface of the table regardless of whether or not air is drawn-in through the through-holes, and the magnetic strips forming the spacers can be arranged such that they do not close-off the through-holes that are needed for applying underpressure to the media.

In a preferred embodiment, it will be, at least among others, the marginal or outer peripheral portions of the overlay that are magnetically drawn against the table. Then, when the print media have a format that is smaller than the size of the support member, the area where underpressure is applied may be limited to the actual area of the print media, so as to avoid leakage of air through the open through-holes in the marginal portion of the overlay, thereby reducing the energy consumption of the vacuum pump. Nevertheless, the magnetic attraction will prevent the overlay from forming warps.

The spacers provided in the peripheral portions of the overlay may be configured as seals for sealing the distribution manifold formed in the gap between the top surface of the table and the bottom surface of the overlay.

The spacers that are distributed over the central part of the overlay may also be formed by magnetic strips. When all spacers are formed by magnetic strips that have exactly the same thickness, the width of the gap between the table and the manifold will be defined with high precision.

When the spacers, i.e. magnetic strips, are detachably secured at the bottom surface of the overlay, the configuration of the spacer array may easily be modified and may thus be adapted to varying sizes of the print media.

Since it is not necessary to punch the overlay and to form recesses in the top surface thereof, in order to provide the spacers at the bottom surface, the top surface of the overlay will be an almost continuous flat surface that is perforated only by the through-holes which may have relatively small diameters so as to prevent the portions of the print media covering these through-holes from being bent.

According to the invention, a method of forming a medium support member of the type that has been described above comprises a step of providing a jig formed with cavities adapted to the contours of the magnetic strips and located in predetermined relative positions, placing magnetic strips in the cavities of the jig, and superposing the overlay and the jig with the magnetic strips contained therein so as to mount the magnetic strips at the predetermined positions on the bottom surface of the overlay.

### BRIEF DESCRIPTION OF THE DRAWINGS

The present invention will become more fully understood from the detailed description given hereinbelow and the accompanying drawings which are given by way of illustration only and are thus not limitative of the invention, and wherein:

FIG. 1 is a schematic view showing a medium support member according to an embodiment of the present invention;

FIG. 2 is a cross-sectional view (not to scale) of the support member showing in FIG. 1;

FIG. 3 is a bottom view of one half of an overlay of the support member shown in FIGS. 1 and 2; and

FIG. 4 is a perspective view of a jag that is used in a method according to the invention for forming the medium support member.

### DETAILED DESCRIPTION OF THE PREFERRED EMBODIMENT

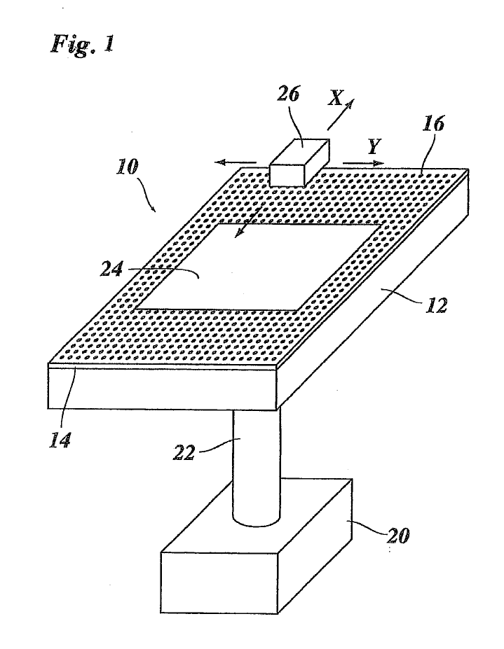

FIG. 1 shows a schematic view of a printing system comprising a medium support member 10 according to an embodiment of the present invention. The support member 10 comprises a table 12 and an overlay 14 positioned on top of the table 12.

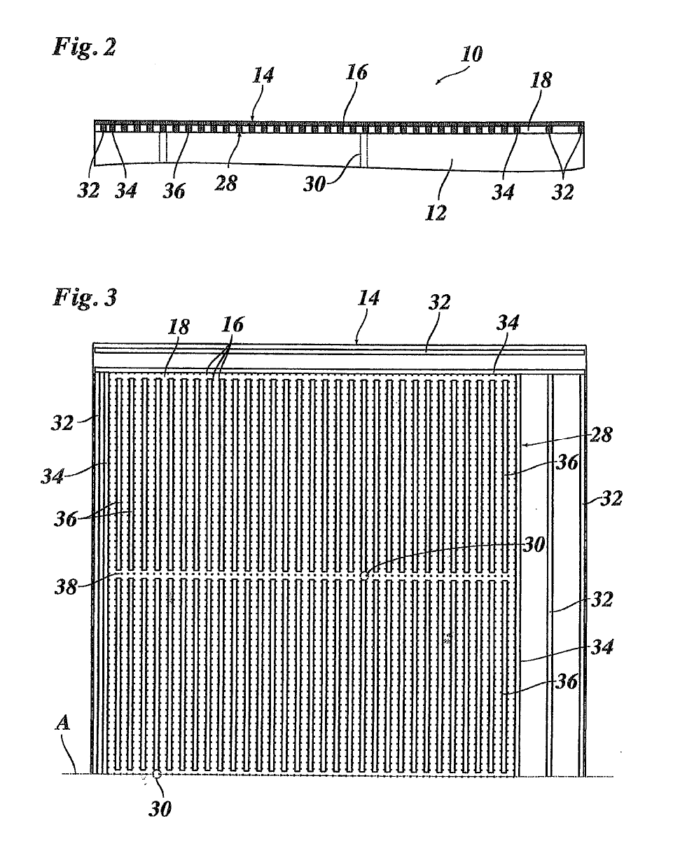

The overlay 14 is perforated by a plurality of through-holes 16 that are regularly distributed over the top surface of the overlay 14. The through-holes 16 connect the top surface of the overlay 14 to the bottom surface thereof (not visible in FIG. 1), where a distribution manifold 18 (FIG. 2) is formed to which an underpressure as applied by means of a vacuum pump 20 (acting as a suction device) and a suction duct 22.

The underpressure causes ambient air to be drawn-in through the through-holes 16. As a consequence, when a sheet of a print medium 24 is supported on the support member 10, the sheet will be firmly sucked against the top surface of the overlay 14. In this way, the medium 24 will be kept stationary and flat. A carriage (not shown) comprising one or more printheads 26 is controlled to move across the print medium 24 to scan the same with high speed in a main scanning direction (fast direction) X and a sub-scanning direction (slow direction) Y, while ink droplets are jetted out from the printhead 26 and onto the medium 24 to form an image thereon. In this embodiment, the printhead 26 ejects droplets of UV-curable ink, but it will be clear for the skilled person that other types of marking material such as solvent ink, water based inks or hot melt inks may be used instead.

In a modified embodiment, the printhead 26 may be moved only in the main scanning direction X to print a swath of the image while the medium 24 is held stationary, and the medium 24 is intermittently advanced in the sub-scanning direction Y so as to print successive swathes.

The dimensions of the overlay 14 and the table 12 may be 3 by 4 meters, for example, and the overlay 12 may be foamed by an aluminum sheet having a thickness of not more than 100 to 150 μm, for example. The through-holes 16 are arranged in rows and columns with a row-to-row distance of 20 mm and may have a diameter of 1.5 mm.

In the cross-sectional view shown in FIG. 2, the dimensions in thickness direction of the overlay 14 have been exaggerated. A spacer array 28 is provided on the bottom surface of the overlay 14, so that a gap with a predetermined height of, e.g., 1.1 mm is formed between the bottom surface of the overlay 14 and the top surface of the table 12.

As can be seen in a bottom plan view in FIG. 3, the spacers of the array 28 are arranged in the form of separated islands, so that the hollow part of the gap not filled by the spacers forms a contiguous distribution manifold 18 capable of evenly applying the underpressure to all of the through-holes 16. As shown in FIG. 2, the manifold 18 is connected to the vacuum duct 22 (FIG. 1) via internal suction passages 30 of the table 12.

FIG. 3 shows only one half of the bottom surface of the overlay 14, the rest of the overlay being symmetric thereto relative to a symmetry axis A. The locations of the mouths of the suction passages 30 have been indicated in the phantom lines.

The individual spacers forming the spacer array 28 are formed by magnetic strips 32-36 that are bonded to the bottom surface of the overlay 14 by means of an adhesive. Some of these strips, designated as 32 and 34, extend along the periphery of the overlay 14 as a kind of frame structure. An innermost frame formed by the strips 34 has the function of a seal that limits and seals the manifold 18. Other, shorter, strips 36 are arranged inside the manifold 18 in parallel lines separated by aisles 38. Thus, the underpressure applied via the suction passages 30 is distributed over the entire surface of the manifold 18 while the overlay 14 is supported in both, the edge portion and the interior portion by the various strips of the spacer array 28. In the example shown, the strips 36 extend in the main scanning direction X. They are arranged in the intervals between every second pair of rows of the through-holes 16, so that, on the one hand, the through-holes 16 are not covered by the strips and, on the other hand, the overlay 14 is particularly supported against the suction force acting in the vicinity of the through-holes 16. Thus, the strips 36 have mutual spacings of 40 mm.

The marginal portions of the overlay 14 which are not perforated by the through-holes 16 are safely attached to the table 12 by means of the frames formed by the magnetic strips 32 and 34, so that the thin overlay 14 is held in a perfectly flat condition even in the marginal areas where no suction pressure is present or where the suction pressure is reduced because the through-holes 16 are not closed-off by the medium 24.

When print media 24 of a different format are to be used, the spacer array 28 may be modified so as to limit and concentrate the suction pressure to the area that is actually covered by the print medium. In this way, it is possible to reduce the number of through-holes 16 that are not covered by the print medium 24 and thereby to reduce the amount of leakage of air through these through-holes.

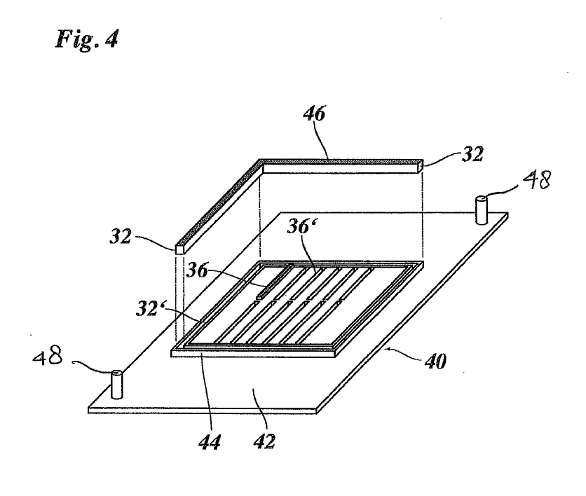

A method of forming the medium support member 10 with a spacer array adapted to a specific format of the print media will now be explained by reference to FIG. 4.

As is shown in FIG. 4, jig 40 is used for positioning the magnetic strips 16, 32 in the correct positions. The jig 40 is formed by a rigid plate 42 forming a mold 44 with cavities 32′, 36′ into which the magnetic strips 36, 32 may be inserted. The cavities 36′, 32′ are adapted to the contours of the respective strips and define the target positions thereof. The depth of the cavities is slightly smaller than the thickness of the strips 36, 32 so that the strips will slightly project out of the cavities, as has been shown for the strip 36 in FIG. 4. The surfaces of the strips 36, 32 that form the top surfaces in FIG. 4 are coated with an adhesive 46. When all strips have been inserted in their respective cavities, the overlay 14 is placed onto the jig 40 and its bottom face is pressed against the projecting strips 16, 32, so that these strips are bonded to the overlay 14. Positioning pins 48 formed on the plate 42 will engage into corresponding positioning holes (not shown) that may be formed in the overlay so as to assure that the strips forming the spacer array 28 will be positioned relative to the pattern of the through-holes 16 with high precision.

Preferably, the butting edges of the strips 32 forming the outer frame of the spacer array will be sealed by means of a curable sealing liquid or the like so as to form an air-tight seal.

Finally the overlay with the strips 32, 36 adhering thereto will be lifted off from the jig 40 and will be placed on the top surface of the table 12. The table 12 is formed of a magnetically attractable steel so that the overlay with the spacer array will be held in place by magnetic attraction between the strips 32, 36 and the table 12.

1. A medium support member comprising:
a table having a top surface;
an overlay placed on the top surface of the table, the overlay having a top surface and a bottom surface and a plurality of through-holes;
a spacer array provided between the top surface of the table and the bottom surface of the overlay to define a gap between the table and the overlay; and
at least one vacuum passage communicating with said gap for creating an underpressure in the gap,
wherein at least portions of the overlay and corresponding portions of the table are held together by magnetic attraction, and
wherein magnetic strips are secured to the overlay, and the the table is made of a magnetically attractable material, and the spacer array comprises spacers that are formed by the magnetic strips.

2. The medium support member according to claim 1, wherein at least some of the spacers formed by magnetic strips are arranged to form a frame that delimits and seals the gap between the bottom surface of the overlay and the top surface of the table.

3. The medium support member according to claim 1, wherein at least some of the spacers formed by magnetic strips are distributed over the bottom surface of the overlay and are separated from one another so that they define an underpressure distribution manifold in the gap between the bottom surface of the overlay and the top surface of the table.

4. The medium support member according to claim 3, wherein the through-holes are regularly arranged in rows and columns, and the magnetic strips forming the spacers are configured as elongated members and are each disposed in an interval between two neighboring rows of the through-holes.

5. The medium support member according to claim 1, wherein the magnetic strips are secured to the overlay by means of an adhesive.

6. The medium support member according to claim 1, wherein said at least one vacuum passage is formed in the table.

7. A method of forming a medium support member comprising a table having a top surface; an overlay placed on the top surface of the table, the overlay having a top surface and a bottom surface and a plurality of through-holes; a spacer array provided between the top surface of the table and the bottom surface of the overlay to define a gap between the table and the overlay; and at least one vacuum passage communicating with said gap for creating an underpressure in the gap, said method comprising the steps of:
providing a jig with a plurality of cavities that define a configuration of the spacer array;
inserting magnetic strips into the cavities of the jig, said magnetic strips projecting out of the cavities and having each a top surface coated with an adhesive;
placing the overlay over the top surfaces of the magnetic strips so as to bond the magnetic strips to the overlay; and
lifting the overlay with the magnetic strips off the jig and placing it on the top surface of the table where the overlay is held in place through magnetic attraction between the magnetic strips and the table.

8. The medium support member according to claim 2, wherein at least some of the spacers formed by magnetic strips are distributed over the bottom surface of the overlay and are separated from one another so that they define an underpressure distribution manifold in the gap between the bottom surface of the overlay and the top surface of the table.

9. The medium support member according to claim 2, wherein the magnetic strips are secured to the overlay by means of an adhesive.

10. The medium support member according to claim 3, wherein the magnetic strips are secured to the overlay by means of an adhesive.

11. The medium support member according to claim 4, wherein the magnetic strips are secured to the overlay by means of an adhesive.
